(19) United States
(12) Patent Application Publication
(10) Pub. No.: US 2022/0104044 A1
(43) Pub. Date: Mar. 31, 2022

(54) Efficient RLM/BFD Measurement in Connected Mode

(71) Applicant: MEDIATEK INC., Hsin-Chu (TW)

(72) Inventors: Din-Hwa Huang, Hsin-Chu (TW); Tsang-Wei Yu, Hsin-Chu (TW); Hsuan-Li Lin, Hsin-Chu (TW); Wei-De Wu, Hsin-Chu (TW)

(21) Appl. No.: 17/471,986

(22) Filed: Sep. 10, 2021

Related U.S. Application Data
(60) Provisional application No. 63/083,822, filed on Sep. 25, 2020.
(60) Provisional application No. 63/165,315, filed on Mar. 24, 2021.

(51) Int. Cl. H04W 24/08; H04L 5/00

(52) U.S. Cl. CPC H04W 24/08; H04L 5/0048

(57) ABSTRACT

Methods are proposed for UE to perform radio link monitoring (RLM) and beam failure detection (BFD) measurements in a relaxed measurement state with an extended evaluation period for power saving. Different criteria for UE to enter and exit the relaxed RLM/BFD measurement state are proposed. In relaxed measurement state, UE can perform RLM/BFD measurements with an extended evaluation period by a scaling factor K when the serving cell quality is higher than a threshold and/or when the serving cell quality variation is lower than a threshold within a time period.

### CROSS REFERENCE TO RELATED APPLICATIONS

This application claims priority under 35 U.S.C. § 119 U.S. provisional application 63/083,822, entitled “Efficient RLM/BFD in Connected Mode” filed on Sep. 25, 2020; U.S. provisional application 63/165,315, entitled “Criteria for RLM/BFD Measurement Relaxation in Connected Mode” filed on Mar. 24, 2021, the subject matter of which is incorporated herein by reference.

### TECHNICAL FIELD

The disclosed embodiments relate generally to wireless communication, and, more particularly, to method and apparatus for radio link monitoring (RLM) and beam failure discovery (BFD) measurement in connected mode in new radio (NR) systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The Next Generation Mobile Network (NGMN) board, has decided to focus the future NGMN activities on defining the end-to-end requirements for 5G new radio (NR) systems.

UEs in radio resource control (RRC) Connected Mode are required to conduct radio link monitoring (RLM) and beam failure discovery (BFD) measurements to monitor radio link quality. For RLM/BFD in NR, UEs can be configured to measure synchronization signal (SS) blocks (SSB) and/or channel state information (CSI) reference signals (CSI-RS). For power saving purpose, it is possible to reduce the number of measured beams, measurement samples, or to extend evaluation period if a UE can guarantee the serving cell quality is good enough for certain period of time. In Rel-16 RRC Idle Mode power saving, there exist two criteria for measurement relaxation. A UE can enter the power saving mode when any or both of the following two criteria is fulfilled: 1) the UE is not in cell edge; and 2) the UE has low mobility.

For Rel-17 connected mode power saving, it is also desired to evaluate: 1) the scaling factor of RLM/BFD measurement relaxation; and 2) the corresponding relaxation criteria.

### SUMMARY

Methods are proposed for UE to perform radio link monitoring (RLM) and beam failure detection (BFD) measurements in a relaxed measurement state with an extended evaluation period for power saving. Different criteria for UE to enter and exit the relaxed RLM/BFD measurement state are proposed. In relaxed measurement state, UE can perform RLM/BFD measurements with an extended evaluation period by a scaling factor K when the serving cell quality is higher than a threshold and/or when the serving cell quality variation is lower than a threshold within a time period.

In one embodiment, a UE receives configuration information of a plurality of reference signals for performing radio link monitoring (RLM) and beam failure discovery (BFD) measurements in a new radio (NR) network. The UE determines whether the UE satisfies criteria for entering a relaxed RLM/BFD measurement state, wherein the criteria comprises at least one of a serving cell quality criteria, and a UE mobility criteria during a period of time. The UE enters the relaxed RLM/BFD measurement state and performs RLM/BFD measurements with a scaling factor K and an extended evaluation period upon satisfying the criteria.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a new radio (NR) wireless system with reference signals (RSs) configured for radio link monitoring (RLM) and beam failure detection (BFD) measurements in accordance with embodiments of the current invention.

FIG. 2 shows simplified block diagrams of a UE and a BS in accordance with embodiments of the current invention.

FIG. 3 illustrates a first embodiment of SINR evaluation methodology under normal method and relaxed method.

FIG. 4 illustrates a second embodiment of SINR evaluation methodology under normal method and relaxed method.

FIG. 5 illustrates one example of an under-estimation issue for SINR evaluation and how to solve the issue.

FIG. 6 illustrates one example of an over-estimation issue for SINR evaluation and how to solve the issue.

FIG. 7 illustrates an example of evaluation results of SINR variation for determining criteria of RLM/BFD measurement relaxation.

FIG. 8 illustrates thresholds for UE to enter and exit power saving mode based on SINR.

FIG. 9 illustrates thresholds for UE to enter and exit power saving mode based on UE speed.

FIG. 10 is a flow chart of a method for determining RLM/BFD measurement relaxation criteria for power saving in accordance with embodiments of the current invention.

### DETAILED DESCRIPTION

Reference will now be made in detail to some embodiments of the invention, examples of which are illustrated in the accompanying drawings.

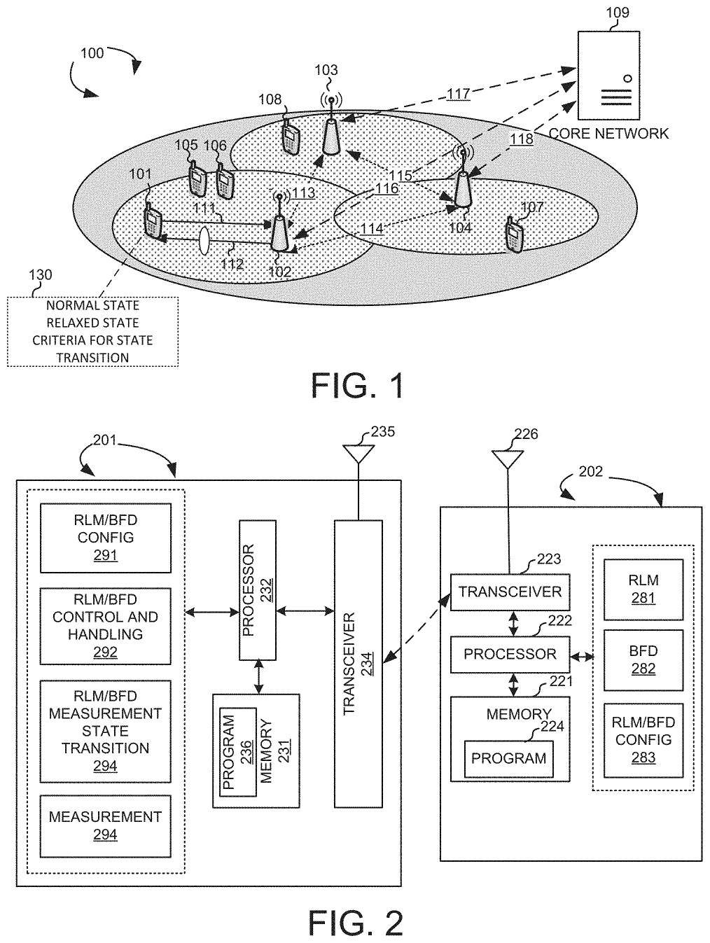

FIG. 1 illustrates a system diagram of a new radio (NR) wireless system 100 with reference signals (RSs) configured for radio link monitoring (RLM) and beam failure detection (BFD) measurements in accordance with embodiments of the current invention. Wireless communication system 100 comprises one or more wireless networks having fixed base infrastructure units, such as wireless communications devices or base units 102 103, and 104, forming wireless radio access networks (RANs) distributed over a geographical region. The base units may also be referred to as an access point (AP), a base station (BS), a Node-B, an eNodeB, an eNB, a gNodeB, a gNB, or by other terminology used in the art. Each of the base unit 102, 103, and 104 serves a geographic area and connects to a core network 109 e.g., via links 116, 117, and 118 respectively. The base unit performs beamforming in the NR system, e.g., in both FR1 (sub7 GHz spectrum) or FR2 (Millimeter Wave frequency spectrum). Backhaul connections 113, 114 and 115 connect the non-co-located receiving base units, such as 102, 103, and 104. These backhaul connections can be either ideal or non-ideal.

A wireless communications device UE 101 in wireless system 100 is served by base station 102 via uplink 111 and downlink 112. Other UEs 105, 106, 107, and 108 are served by different base stations. UEs 105 and 106 are served by base station 102. UE 107 is served by base station 104. UE 108 is served by base station 103. Each UE may be a smart phone, a wearable device, an Internet of Things (IoT) device, a tablet, etc. For radio link monitoring (RLM) in NR, each UE can be configured to measure synchronization signal (SS) blocks (SSB) and/or channel state information (CSI) reference signal (CSI-RS). With explicit signaling, after UE is connected to a cell, the RLM RS configuration parameters can be configured through radio resource control (RRC) signaling via RadioLinkMonitoringRS, including RS type (SSB or CSI-RS) and RS ID. For CSI-RS, the parameters include CSI-RS Index that is linked to CSI-RS resource configuration, which further includes resource location in time and frequency domain and quasi-co-location (QCL) info through beam indication or transmission configuration indication (TCI) state. For SSB, the parameters include SSB Index that is used to derive SSB location in time domain.

UEs in RRC Connected Mode are required to conduct RLM and beam failure discovery (BFD) measurements to monitor radio link quality. For power saving purpose, it is possible to reduce the number of measured beams, measurement samples, or to extend evaluation period if a UE can guarantee the serving cell quality is good enough for certain period of time. In accordance with one novel aspect, methods are proposed for UE to perform RLM and BFD measurements in a relaxed measurement state with an extended evaluation period for power saving. In a normal measurement state, UE is assumed to be moving normally and fulfills normal evaluation period requirements. In a relaxed measurement state, UE is moving slow during a period of time and/or the serving cell signal quality is high, which can fulfill the extended evaluation period requirements. Different criteria for UE to enter power saving mode and perform RLM/BFD measurements with a scaling factor and an extended evaluation period are proposed. Conditions for UE to enter relaxed measurement state and exit back to normal measurement state are also proposed.

FIG. 2 shows simplified block diagrams of a wireless devices, e.g., UE 201 and base station 202 in accordance with the current invention. Base station 202 has an antenna 226, which transmits and receives radio signals. A RF transceiver module 223, coupled with the antenna, receives RF signals from antenna 226, converts them to baseband signals and sends them to processor 222. RF transceiver 223 also converts received baseband signals from processor 222, converts them to RF signals, and sends out to antenna 226. Processor 222 processes the received baseband signals and invokes different functional modules to perform features in base station 202. Memory 221 stores program instructions and data 224 to control the operations of base station 202. Base station 202 also includes a set of control modules and circuits, such as an RLM handling circuit 281 that performs RLM, BFD handling circuit 282 that performs BFD, and an RLM/BFD configuration circuit 283 that configures RLM and BFD and corresponding measurements for UEs and communicates with UEs to implement the RLM/BFD functionalities.

Similarly, UE 201 has an antenna 235, which transmits and receives radio signals. A RF transceiver module 234, coupled with the antenna, receives RF signals from antenna 235, converts them to baseband signals and sends them to processor 232. RF transceiver 234 also converts received baseband signals from processor 232, converts them to RF signals, and sends out to antenna 235. Processor 232 processes the received baseband signals and invokes different functional modules to perform features in mobile station 201. Memory 231 stores program instructions and data 236 to control the operations of mobile station 201. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

UE 201 also includes a set of control modules and circuits that carry out functional tasks. These functions can be implemented in software, firmware and hardware. A processor in associated with software may be used to implement and configure the functional features of UE 201. For example, an RLM/BFD configuration circuit 291 that configures SSB and CSI-RS resources for RLM/BFD; an RLM/BFD control and handling circuit 292 that determines whether and how to perform RLM/BFD based on the RLM/BFD configuration; a measurement state transition handling circuit 293 that handles normal state and relaxed state transition based on different criteria, and a measurement circuit 294 that performs normal or relaxed RLM/BFD measurements accordingly.

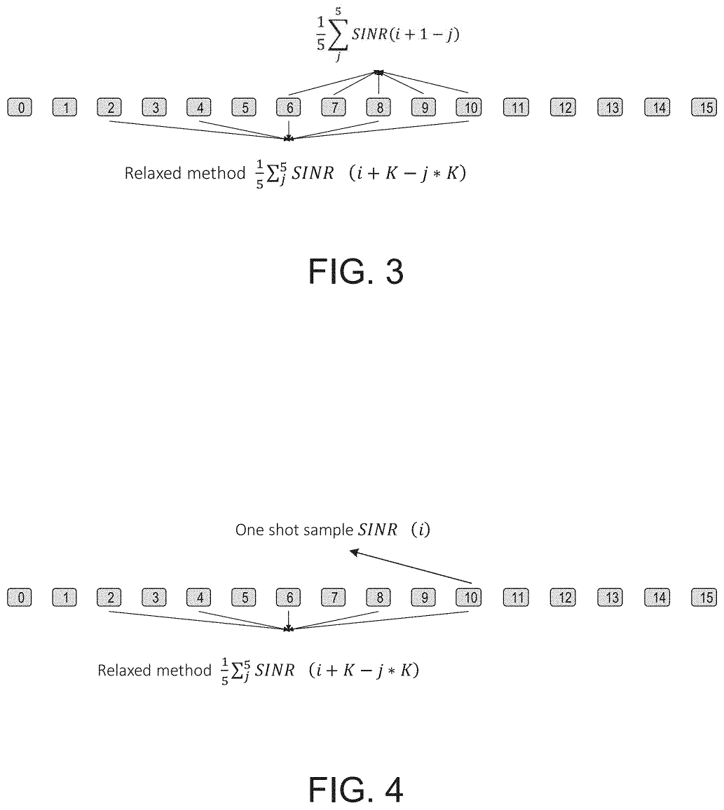

FIG. 3 illustrates a first embodiment of SINR evaluation methodology under normal method and relaxed method. In FIG. 3, each number represents one reference signal (either SSB or CSI-RS). Under normal method, SINR_{NORMAL} is obtained by averaging with 5 samples, and the time interval between each sample is one DRX cycle for FR1, eight DRX cycle for FR2. Under relaxed method with scaling factor K, SINR_{RELAXED} is obtained by averaging with five samples, and the time interval between each sample is K*1 DRX cycle for FR1, and K*8 DRX cycle for FR2. In one example, K=2 for FR1. As illustrated in FIG. 3, the SINR variation ΔSINR is:

$${Δ}_{SINR} ( i ) = \frac{1}{5} {\sum }_{j}^{5} SINR ( i + K - j * K ) - \frac{1}{5} {\sum }_{j}^{5} SINR ( i + 1 - j ) \qquad$$

FIG. 4 illustrates a second embodiment of SINR evaluation methodology under normal method and relaxed method. In FIG. 3, each number represents one reference signal (either SSB or CSI-RS). Under normal method, SINR_{NORMAL} is obtained by taking only one sample one shot SINR value. Under relaxed method with scaling factor K, SINR_{RELAXED} is obtained by averaging with five samples, and the time interval between each sample is K*1 DRX cycle for FR1, and K*8 DRX cycle for FR2. In one example, K=2 for FR1. As illustrated in FIG. 4, the SINR variation SINR_{VARI} is:

$${SINR}_{vari} ( i ) = \frac{1}{5} {\sum }_{j}^{5} SINR ( i + K - j * K ) - SINR ( i ) \qquad$$

As illustrated earlier, in a normal measurement state, UE is assumed to be moving normally and fulfills normal evaluation period requirements. In a relaxed measurement state, UE is moving slow during a period of time and/or the serving cell signal quality is high, which can fulfill the extended evaluation period requirements. Good serving cell quality criteria of RLM/BFD relaxation is defined as the radio link quality is better than a threshold. UE can reuse the SINR for RLM/BFD evaluation when determine whether the serving cell quality criteria is fulfilled or not. However, SINR varies during the evaluation period, and UE may under-estimate or over-estimate SINR causing false alarm or mis-detection of the serving cell quality.

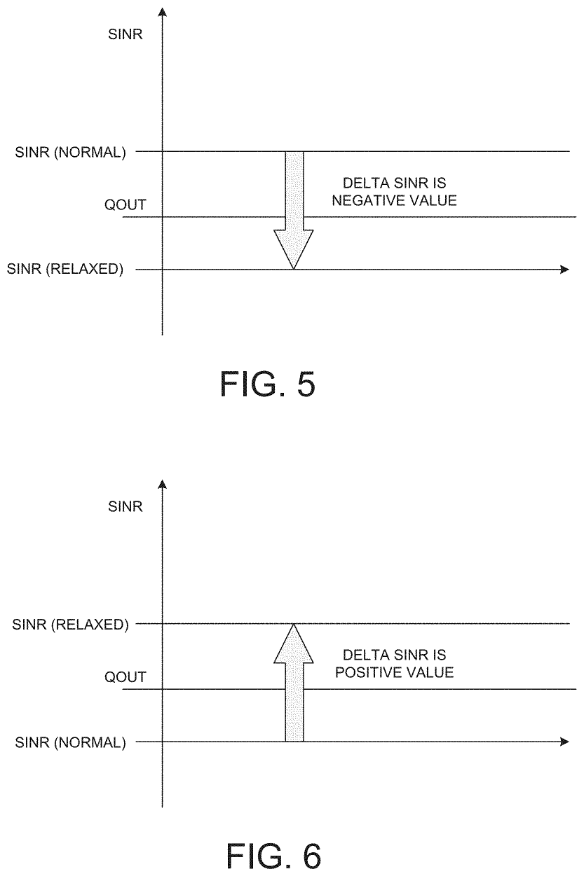

FIG. 5 illustrates one example of an under-estimation issue for SINR evaluation and how to solve the issue. Because SINR varies during the evaluation period, the value of SINR_{RELAXED} may be much lower than the SINR_{NORMAL} under certain condition, especially when the evaluation period is long. As a result, if a UE is in relaxed measurement state, then the UE may under-estimate the actual SINR and create a false alarm. As depicted in FIG. 5, the UE may wrongly conclude that the serving cell SINR value is lower than a threshold value of Qout. This issue can be avoided if the serving cell quality (e.g., average SINR over RS samples during the evaluation period) is higher than the absolute value of the negative SINR variation ΔSINR plus the threshold Qout: SINR>|negative ΔSINR|+Qout.

FIG. 6 illustrates one example of an over-estimation issue for SINR evaluation and how to solve the issue. Because SINR varies during the evaluation period, the value of SINR_{RELAXED} may be much higher than the SINR_{NORMAL} under certain condition, especially when the evaluation period is longer. As a result, if a UE is in relaxed measurement state, then the UE may over-estimate the actual SINR and mis-detect bad signal quality of the serving cell. As depicted in FIG. 5, the UE may wrongly conclude that the serving cell SINR value is higher than a threshold value of Qout. This issue can be avoided if the serving cell quality (e.g., average SINR over RS samples during the evaluation period) is higher than the absolute value of the positive SINR variation ΔSINR plus the threshold Qout: SINR>|positive ΔSINR|+Qout.

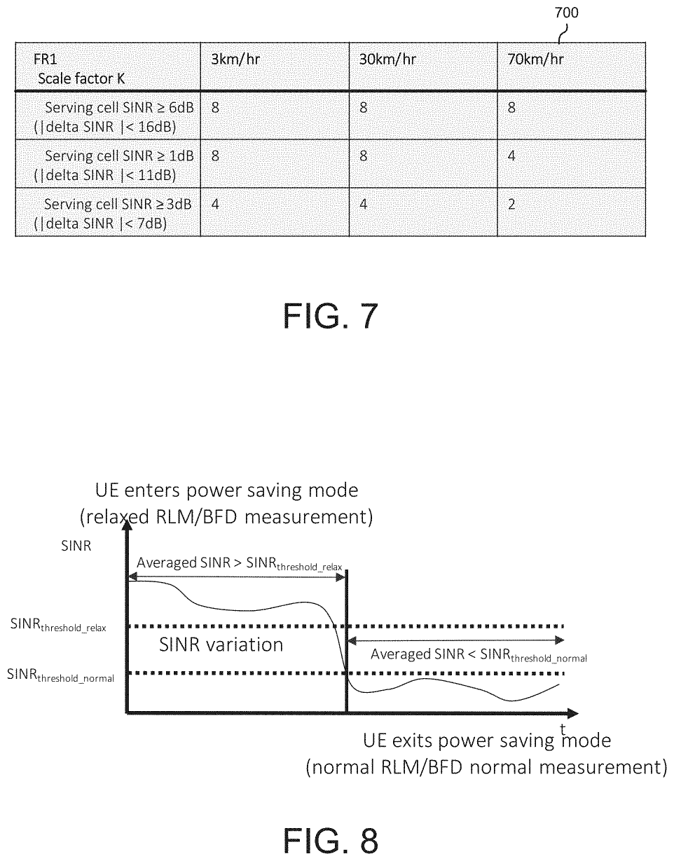

FIG. 7 illustrates an example of evaluation results of SINR variation for determining criteria of RLM/BFD measurement relaxation. Table 700 of FIG. 7 depicts the scaling factor K in FR1 of RLM/BFD measurement relaxation with different UE speed and SINR serving cell signal quality. When serving cell quality is larger than a particular threshold and UE speed is slow enough, we can guarantee that serving cell quality will not be lower than Qout (set as −10 dB), considering that the delta SINR variation @ 1% and 99%. In a first example, if |ΔSINR|<16 dB, then serving cell SINR>16-10 dB=6 dB satisfies the relaxed measurement criteria, and K=8 for all UE speed. In a second example, if |ASINR|<11 dB, then serving cell SINR>16-10 dB=1 dB satisfies the relaxed measurement criteria, and K=8 for UE speed 3 km-30 km/hour, and K=4 for UE speed 70 km/hour. In a third example, if |ASINR|<7 dB, then serving cell SINR>7-10 dB=−3 dB satisfies the relaxed measurement criteria, and K=4 for UE speed 3 km-30 km/hour, and K=2 for UE speed 70 km/hour.

There are different criteria for UE to enter relaxed RLM/BFD measurement state for power saving. A first criteria A1 is channel condition (e.g. SINR or SNR) of a serving cell or a serving beam (beam level)-Serving cell SNR/SINR is larger (or not lower) than certain threshold SINR_{threshold_relax} or SNR_{threshold_relax}. In one example, UE determines the relaxation factor K=4 when −3 dB <=SNR/SINR<=1 dB. In another example, UE determines the relaxation factor K=8 when 1 dB<=SNR/SINR.

A second criteria B1 is UE speed is low, determined based on serving cell SNR/SINR variation is lower (or not larger) than SNR_{delta_relax} or SINR_{delta_relax} within time period T_{delta_relax}. The SNR/SINR variation can be: 1) The difference between the max. SNR/SINR during time period T_{delta_relax} and the min. SNR/SINR during time period T_{delta_relax}; 2) The difference between the max. SNR/SINR during time period T_{delta_relax} and the latest SNR/SINR measured in T_{delta_relax}, or 3) The difference between the min. SNR/SINR during time period T_{delta_relax} and the latest SNR/SINR measured in T_{delta_relax}. The T_{delta_relax} can be the latest RLM/BFD evaluation period. The parameter of SNR_{threshold_relax}, SINR_{threshold_relax}, SNR_{delta_relax}, SINR_{delta_relax}, and T_{delta_relax} can be the Network indicated values or the predefined values in the 3GPP spec.

A third criteria C1 is channel condition (e.g. RSRP) of a serving cell-Serving cell RSRP is larger (or not lower) than certain threshold RSRP_{threshold_relax}. In one example, UE determines the relaxation factor as K=4 when −3 dB<=RSRP<=1 dB. In another example, UE determines the relaxation factor as K=8 when 1 dB<=RSRP.

A fourth criteria D1 is UE speed is low, determined based on serving cell RSRP variation is lower (or not larger) than RSRP_{delta_relax} within time period T_{delta_relax}. The RSRP variation can be: 1) The difference between the max. RSRP during time period T_{delta_relax} and the min. RSRP during time period T_{delta_relax}; 2) The difference between the max. RSRP during time period T_{delta_relax} and the latest RSRP measured in T_{delta_relax}, or 3) The difference between the min. RSRP during time period T_{delta_relax} and the latest RSRP measured in T_{delta_relax}. The T_{delta_relax} can be the latest RLM/BFD evaluation period. The parameter of RSRP_{threshold_re;ax}, RSRP_{delta_relax}, and T_{delta_relax} can be the Network indicated values or the predefined values in the 3GPP spec. The current RSRP can be measured based on L1-RSRP or SS-RSRP, using one RS sample or over the RLM evaluation period.

Similarly, there are different criteria for UE to exit relaxed RLM/BFD measurement state and go back to normal RLM/BFD measurement state. A first criteria A1 is channel condition (e.g. SINR or SNR) of a serving cell or a serving beam (beam level)-Serving cell SNR/SINR is lower (or not larger) than certain threshold SINR_{threshold_normal} or SNR_{threshold_normal}. A second criteria B2 is UE speed, determined based on serving cell SNR/SINR variation is larger (or not lower) than SNR_{delta_normal} or SINR_{delta_normal} within time period T_{delta_normal}. A third criteria C2 is channel condition (e.g. RSRP) of a serving cell-Serving cell RSRP is lower (or not larger) than certain threshold RSRP_{threshold_normal}. A fourth criteria D2 is UE speed, determined based on serving cell RSRP variation is larger (or not lower) than RSRP_{delta_normal} within time period T_{delta_normal}.

In one embodiment, UE will enter the RLM/BFD measurement relaxation when any one condition of relax criteria A1, B1, C1, D1 is fulfilled, any two conditions of relax criteria A1, B1, C1, D1 are fulfilled, any 3 conditions of relax criteria A1, B1, C1, D1 are fulfilled, or all conditions of relax criteria A1, B1, C1, D1 are fulfilled. In another embodiment, UE will exit the RLM/BFD measurement relaxation when any one condition of relax criteria A2, B2, C2, D2 is fulfilled, any two conditions of relax criteria A2, B2, C2, D2 are fulfilled, any 3 conditions of relax criteria A2, B2, C2, D2 are fulfilled, or all conditions of relax criteria A2, B2, C2, D2 are fulfilled.

FIG. 8 illustrates thresholds for UE to enter and exit power saving mode based on SINR. In the example of FIG. 8, the channel condition threshold (SINR, SNR, or RSRP) under relaxed state is larger than the channel condition threshold under normal state. In one example, UE enters power saving mode when the averaged SINR>SINR_{threshold_relaxed}, and UE exits power saving mode when the average SINR<SINR_{threshold_normal}.

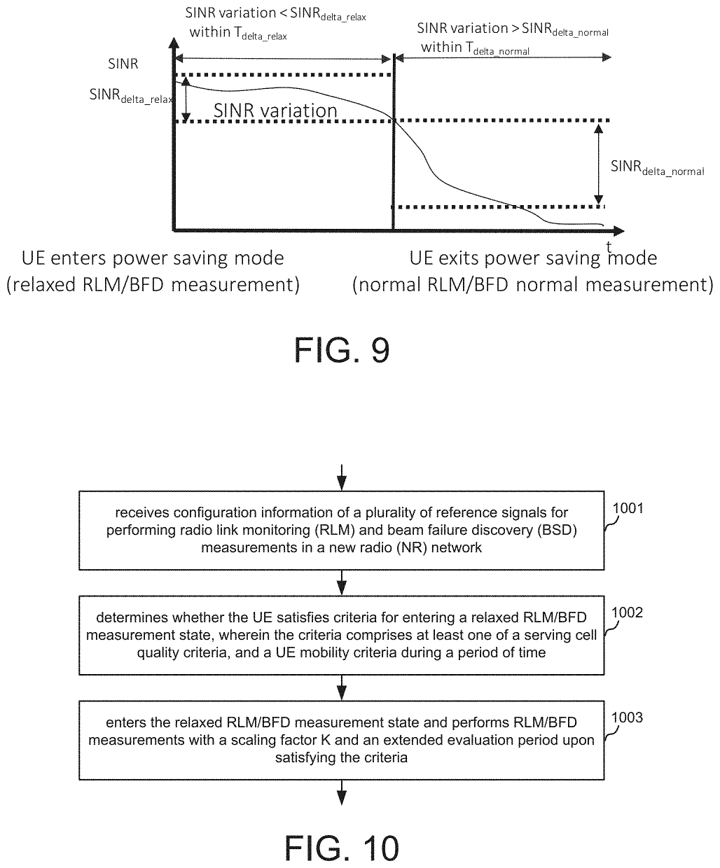

FIG. 9 illustrates thresholds for UE to enter and exit power saving mode based on UE speed. In the example of FIG. 9, the channel condition variation (SINR, SNR, or RSRP) under relaxed state is smaller than the channel condition variation under normal state. In one example, UE enters power saving mode when the averaged ΔSINR<SINR_{delta_relax}, and UE exits power saving mode when the average ΔSINR>SINR_{delta_normal}.

FIG. 10 is a flow chart of a method for determining RLM/BFD measurement relaxation criteria for power saving in accordance with embodiments of the current invention. In step 1001, a UE receives configuration information of a plurality of reference signals for performing radio link monitoring (RLM) and beam failure discovery (BSD) measurements in a new radio (NR) network. In step 1002, the UE determines whether the UE satisfies criteria for entering a relaxed RLM/BFD measurement state, wherein the criteria comprises at least one of a serving cell quality criteria, and a UE mobility criteria during a period of time. In step 1003, the UE enters the relaxed RLM/BFD measurement state and performs RLM/BFD measurements with a scaling factor K and an extended evaluation period upon satisfying the criteria.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving configuration information of a plurality of reference signals for performing radio link monitoring (RLM) and beam failure discovery (BFD) measurements by a user equipment (UE) in a new radio (NR) network;
determining whether the UE satisfies criteria for entering a relaxed RLM/BFD measurement state, wherein the criteria comprises at least one of a serving cell quality criteria, and a UE mobility criteria during a period of time; and
entering the relaxed RLM/BFD measurement state and performing RLM/BFD measurements with a scaling factor K and an extended evaluation period upon satisfying the criteria.

2. The method of claim 1, wherein the serving cell quality is determined based on a signal to interference plus noise ratio (SINR), or a signal to noise ratio (SNR), or a reference signal received power (RSRP).

3. The method of claim 2, wherein the serving cell quality criteria is satisfied when an average SINR/SNR/RSRP value is higher than a first threshold during the period of time.

4. The method of claim 3, wherein the UE exits the relaxed RLF/BFD measurement state when the average SINR/SNR/RSRP value is lower than a second threshold during the period of time.

5. The method of claim 4, wherein the first threshold and the second threshold are either predefined or indicated by the network.

6. The method of claim 1, wherein the UE mobility is determined based on a signal to interference plus noise ratio (SINR) variation, or a signal to noise ratio (SNR) variation, or a reference signal received power (RSRP) variation during the period of time.

7. The method of claim 6, wherein the UE mobility criteria is satisfied when a SINR/SNR/RSRP variation is lower than a first threshold during a first period of time.

8. The method of claim 7, wherein the UE exits the relaxed RLF/BFD measurement state when the SINR/SNR/RSRP variation is higher than a second threshold during a second period of time.

9. The method of claim 8, wherein the first threshold, the first period of time, the second threshold, and the second period of time are either predefined or indicated by the network.

10. The method of claim 1, wherein a time interval between each measurement for the relaxed RLM/BFD measurement state is K times longer than a time interval for a normal RLM/BFD measurement state.

11. The method of claim 1, wherein the extended evaluation period for the relaxed RLM/BFD measurement state is K times longer than an evaluation period for a normal RLM/BFD measurement state.

12. The method of claim 1, wherein the scaling factor K is determined based on a predefined value, or a threshold value of the serving cell signal quality, or a threshold value of the UE mobility.

13. A User Equipment (UE) comprising:
a receiver that receives configuration information of a plurality of reference signals for performing radio link monitoring (RLM) and beam failure discovery (BFD) measurements in a new radio (NR) network;
a control circuit that determines whether the UE satisfies criteria for entering a relaxed RLM/BFD measurement state, wherein the criteria comprises at least one of a serving cell quality criteria, and a UE mobility criteria during a period of time; and
a measurement handling circuit that enters the relaxed RLM/BFD measurement state and performs RLM/BFD measurements with a scaling factor K and an extended evaluation period upon satisfying the criteria.

14. The UE of claim 13, wherein the serving cell quality is determined based on a signal to interference plus noise ratio (SINR), or a signal to noise ratio (SNR), or a reference signal received power (RSRP).

15. The UE of claim 14, wherein the serving cell quality criteria is satisfied when an average SINR/SNR/RSRP value is higher than a first threshold during the period of time.

16. The UE of claim 15, wherein the UE exits the relaxed RLF/BFD measurement state when the average SINR/SNR/RSRP value is lower than a second threshold during the period of time.

17. The UE of claim 13, wherein the UE mobility is determined based on a signal to interference plus noise ratio (SINR) variation, or a signal to noise ratio (SNR) variation, or a reference signal received power (RSRP) variation during the period of time.

18. The UE of claim 17, wherein the UE mobility criteria is satisfied when a SINR/SNR/RSRP variation is lower than a first threshold during a first period of time.

19. The UE of claim 18, wherein the UE exits the relaxed RLF/BFD measurement state when the SINR/SNR/RSRP variation is higher than a second threshold during a second period of time.

20. The UE of claim 13, wherein a time interval between each measurement for the relaxed RLM/BFD measurement state is K times longer than a time interval for a normal RLM/BFD measurement state.

21. The UE of claim 13, wherein the extended evaluation period for the relaxed RLM/BFD measurement state is K times longer than an evaluation period for a normal RLM/BFD measurement state.

22. The UE of claim 13, wherein the scaling factor K is determined based on a predefined value, or a threshold value of the serving cell signal quality, or a threshold value of the UE mobility.
